(19) United States
(12) Patent Application Publication
(10) Pub. No.: US 2003/0035691 A1
(43) Pub. Date: Feb. 20, 2003

(54) Permeable-reactive barrier monitoring method and system

(76) Inventors: Timothy M. Sivavec, Clifton Park, NY (US); Angelo Anthony Bracco, Albany, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/682,142

(22) Filed: Jul. 26, 2001

(51) Int. Cl. C02F 7/00; B09B 1/00; G21F 9/00; E02B 1/00

(52) U.S. Cl. 405/128.1; 405/128.3; 210/747; 210/170

(57) ABSTRACT

A method comprises conducting a permeable-reactive barrier (PRB) treatment of a contaminated aqueous medium and in-well monitoring effectiveness of the permeable-barrier treatment. A system comprises a PRB zone to treat a contaminated groundwater and an in-well sensor located within a gradient of the contaminated groundwater or within the PRB zone to sense a characteristic of the groundwater.

### BACKGROUND OF INVENTION

The present invention relates to a permeable-reactive barrier monitoring method Dand system. Particularly, the invention relates to an in-well sensor method and system to monitor and control a permeable-reactive barrier zone.

The use of a permeable-reactive barrier (PRB) is an attractive groundwater restoration technology. A PRB is a permeable reactive zone that is placed in the path of a migrating plume of contaminated groundwater. The PRIB intercepts the containment plume and removes contaminants from the plume solution using chemical and/or biological reactions. See Innovations in Groundwater and Soil Cleanup, National Academy Press, p. 90, 1997. PRBs can mitigate the spread of contaminants that have proven difficult and expensive to manage with other methods. PRBs are characterized by advantageous cost to benefit ratios.

In a PRB system, reactive material such as recycled cast iron (zero-valent iron) is placed into the subsurface to intercept a plume of contaminated groundwater, which passes through the reactive material under its natural gradient. As the groundwater passes through the granular iron material, the contaminants are adsorbed to the iron and are reduced to nontoxic end products.

A PRB is designed to provide a set residence time for decontamination of the contaminated plume. The PRB design is determined by the concentration of contaminants, the natural groundwater flow and the degradation rate for the contaminants in the presence of the PRB reactive material. A wide variety of chlorinated hydrocarbons, including chlorinated ethenes such as trichloroethene (TCE) and tetrachloroethene (PCE) and their products, dichloroethene (DCE) and vinyl chloride (VC), are effectively treated by this method, often at a significant cost savings when compared to conventional pump-and-treat alternatives.

Compliance monitoring of PRBs typically involves sampling of contaminants of interest at locations where dissolved concentrations have been detected that exceed regulatory limits. Compliance monitoring can include general water quality monitoring to measure major cations and anions and alkalinity. Compliance monitoring can also include other water quality indicator parameters such as pHI, dissolved oxygen, specific conductance and oxidation-reduction potential.

Flow sampling methods involving well purging are typically used for PRB compliance purposes. In well purging, a sample is withdrawn from the groundwater and is pumped to ground surface for measurement and collection. However, when purging of a well takes place, a significant volume of water surrounding the well may be drawn into the well borehole. The flow of the drawn water into the well borehole interrupts the natural groundwater flow that is the basis of the PRB design. The radius of adverse influence of purging can be quite large depending upon the pumping rate employed. Further, if the well is within the barrier zone, purging samples may include water that has not yet been fully treated.

Another method of monitoring PCBs comprises passive ground water sampling. In this method, a sample is collected within a fully cased monitoring well. The well can have screened, externally sandpacked sections at or near the well bottom. The sections are intended to delimit the zone of sampling interest. Ideally, flow through the screened intervals consists only of waters that would naturally move through the formation at that depth. Again ideally, the waters remain chemically unchanged while passing into the well bore.

A passive ground water sampling method lessens interruption of natural flow.

However, the integrity of a passive sample can be jeopardized by the action of pumping to the surface for above-surface measurement and collection. The action of pumping can introduce atmospheric gases into the sample, even when low-flow purging techniques are employed. Pumping can introduce dissolved oxygen that will significantly affect parameters such as dissolved O₂ and oxidation-reduction potential. This introduces error into the groundwater parameter measurements.

There is a need for a PRB compliance monitoring method and system that avoids purging and concomitant interruption of groundwater natural flow and that maintains sample integrity.

### SUMMARY OF INVENTION

The invention relates to a monitoring method and system that avoids well purging and interruption of groundwater natural flow and sampling error. According to the invention, a method comprises conducting a permeable-reactive barrier treatment of a contaminated aqueous medium and in-well monitoring effectiveness of the permeable-barrier treatment.

In an embodiment, the invention relates to a method of treating a contaminated groundwater, comprising sensing a characteristic of the contaminated groundwater with a sensor placed in at least one well emplaced substantially along a transect of a longitudinal axis of a PRB zone and remotely monitoring the sensing to determine effectiveness of a remediation treatment of the groundwater.

In another embodiment, the invention relates to a system comprising a PRB zone to treat a contaminated groundwater and an in-well sensor located within a gradient of the contaminated groundwater or within the PRB zone to sense a characteristic of the groundwater.

### BRIEF DESCRIPTION OF DRAWINGS

FIG. 1 is a schematic representation of a PRB treatment area with emplaced monitoring wells;

FIG. 2 is a schematic overhead representation of a PRB zone;

FIG. 3 is a schematic representation of a well with emplaced monitoring sensor;

FIG. 4 is a schematic representation of a sensing and monitoring system; and

FIGS. 5 to 12 are graphs of monitored PRB parameters.

### DETAILED DESCRIPTION

PRB systems and methods are used to treat and degrade chemicals in groundwater in situ. In a PRB method, a permeable, subsurface barrier containing a reactive material (such as granular iron) is constructed across the path of a contaminant plume. When groundwater passes through the reactive barrier zone, contaminants are either immobilized or chemically transformed to a more desirable (e.g., less toxic or more readily biodegradable) state. For example, when a chlorinated hydrocarbon such as trichloroethylene (TCE), contacts iron metal, a reductive dechlorination reaction occurs that degrades the TCE to less hazardous compounds. Since the groundwater typically moves under its natural gradient, the PRB is a “passive” (i.e., not requiring an external energy source) treatment system.

In a PRB process, a contaminant is first identified, and at plume of the contaminant is mapped: its extent, its depth, velocity and other characteristics are determined. A trench is excavated or other receptacle is placed in ground. A body of biologically or chemically reactive material is placed into the trench or receptacle. The location and extent of the trench or receptacle barrier are such that the plume of contaminant is caused to pass through the PRB material.

According to the invention, monitoring wells are located in the vicinity of the PRB reactive barrier zone to provide in-well monitoring of treatment parameters. Wells can be located up-gradient and down-gradient of the PRB as well as within the reactive material of the PRB zone, itself. The monitoring system comprises an in-well unit containing at least one sensor. The unit may include any number of sensors that may be used to monitor groundwater characteristics. The unit is placed down the groundwater monitoring well, typically at the mid-point of the screened interval. Comparison of groundwater data collected within the reactive material and outside the material, both up-gradient and down-gradient can be used to observe changes that the barrier material promotes in the groundwater. The invention can measure important field indicator parameters (sometimes called groundwater quality parameters) without requiring retrieval of formation water by use of a pump. Additionally, the invention provides a method to gain such data in near, real-time and to access such data remotely.

Monitoring wells can be placed up to about 25 feet up-gradient of the PRB and up to about 25 feet down-gradient of the PRB. Desirably, the wells are placed about 1 to about 6 feet up-gradient and down-gradient of the PRB and preferably about 2 to about 4 feet up- and down-gradient. Up-gradient means in front of the PRB/groundwater interface, down-gradient means behind the trailing PRB/groundwater interface. Preferably, a plurality of wells is emplaced substantially along a transect that intersects the longitudinal axis of the PRB zone. At least one up-gradient monitoring well and at least one down-gradient well can be included on the transect. The transect can be described as a ±20 feet wide plane that transcribes at least one up-gradient monitoring well and at least one down-gradient well at a level that is ±5 feet of a mid point of each well open screen interval. Desirably, the transect is described as a ±10 feet wide plane that transcribes the wells at a level that is ±3 feet of the open screen intervals and preferably the transect is a ±6 wide plane that is ±1 feet of the interval mid-points. Additionally, one or more monitoring wells can be emplaced within the reactive material of the PRB zone, itself.

The up-gradient and down-gradient placement provides a comparison of groundwater parameters such as pH, specific conductance, dissolved oxygen, oxidation-reduction potential, temperature and turbidity with parameters within the reactive material of the PRB. An up-gradient monitoring point provides a baseline measurement of groundwater characteristics before the groundwater comes in contact with the iron media. The monitoring points within the iron PIRB indicate performance of the iron media. (i.e., any change in the reducing environment provided by the iron media as evidenced by pH, oxidation-reduction potential).

The function of a down-gradient sensor location is to monitor return of the groundwater to a natural state. For example, pH, oxidation--reduction potential and specific conductance can be measured and compared to values at an up-gradient well. For example the following value profile can be observed:

TABLE 1

| | Up-Gradient | PRB | Down-Gradient |
|---|---|---|---|
| pH | −7 | 9 to 11 | −7 |
| ORP | 0mV to −200 mV | −300 mV to −800 mV | 0mV to |
| | (aerobic aquifer) | | −200 mV |
| | | | (aerobic |
| | | | aquifer) |
| Specific | 0.6 to 1.0 mS/cm | 0.3 to 0.5 mS/cm | 0.6 to 1.0 |
| Conductance | | | mS/cm |

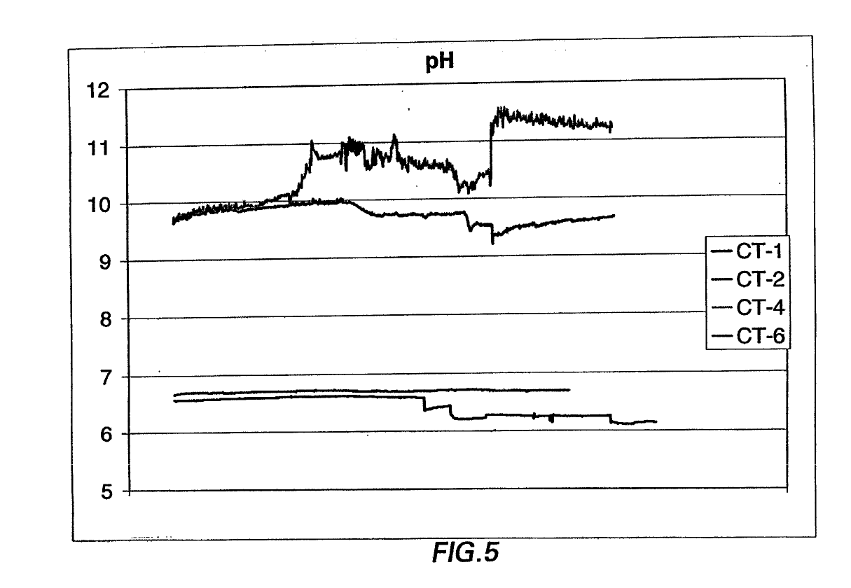

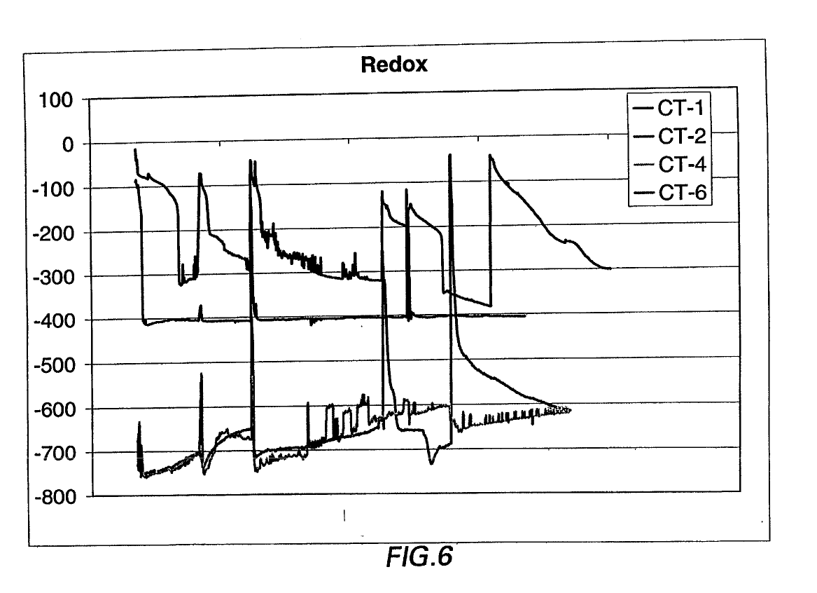

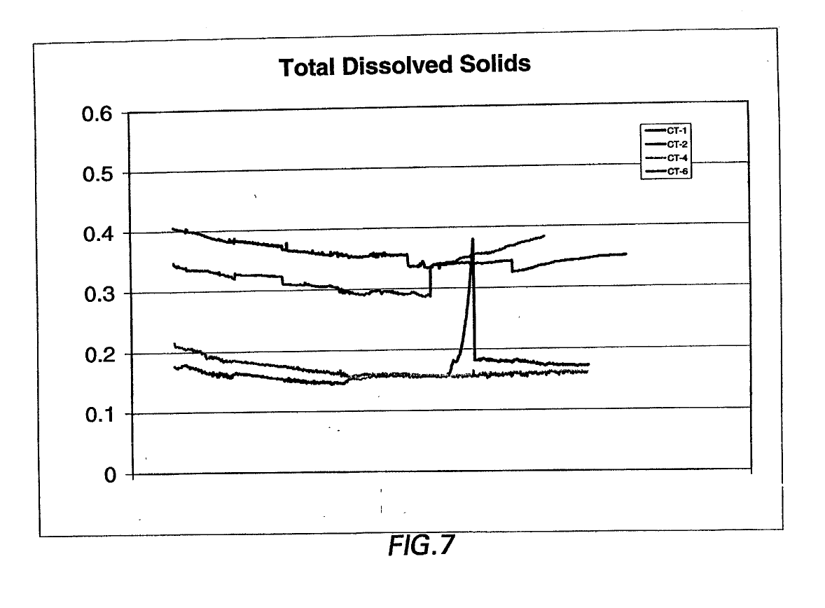

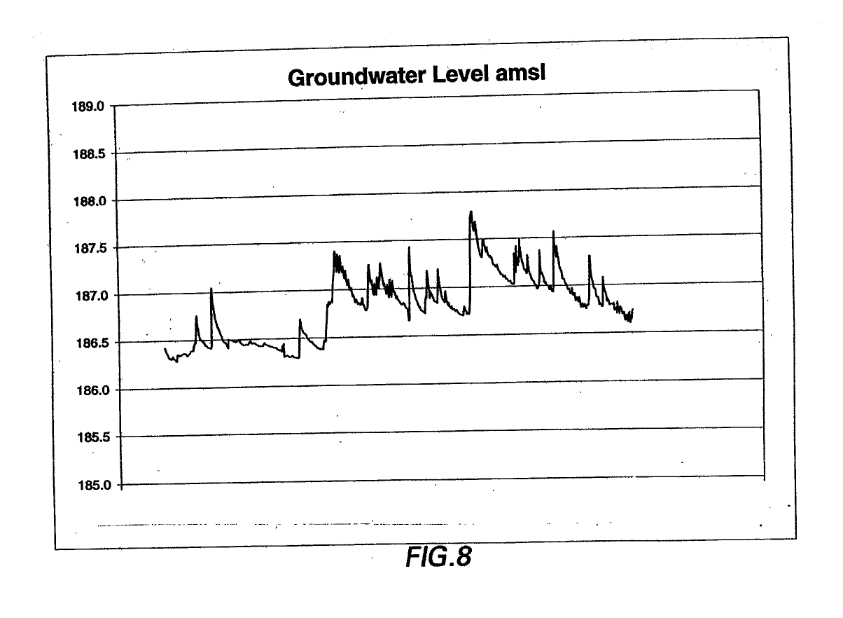

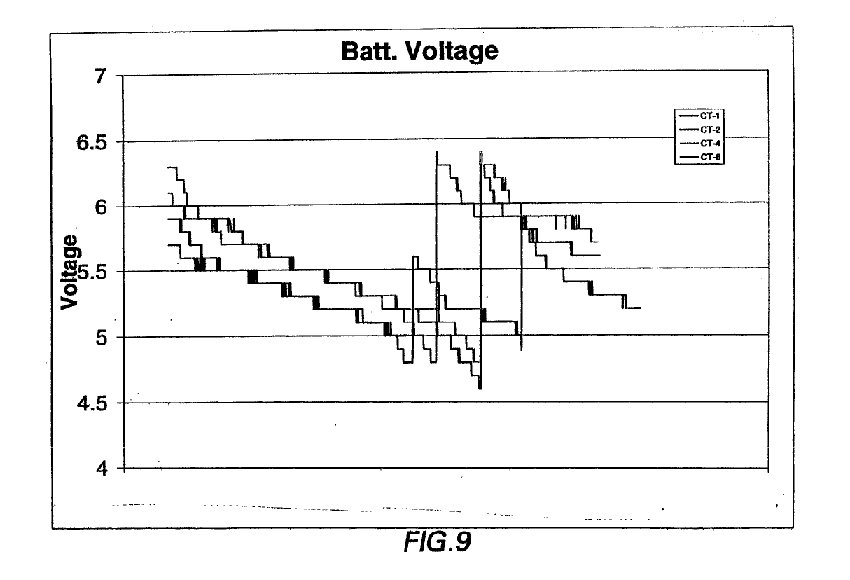

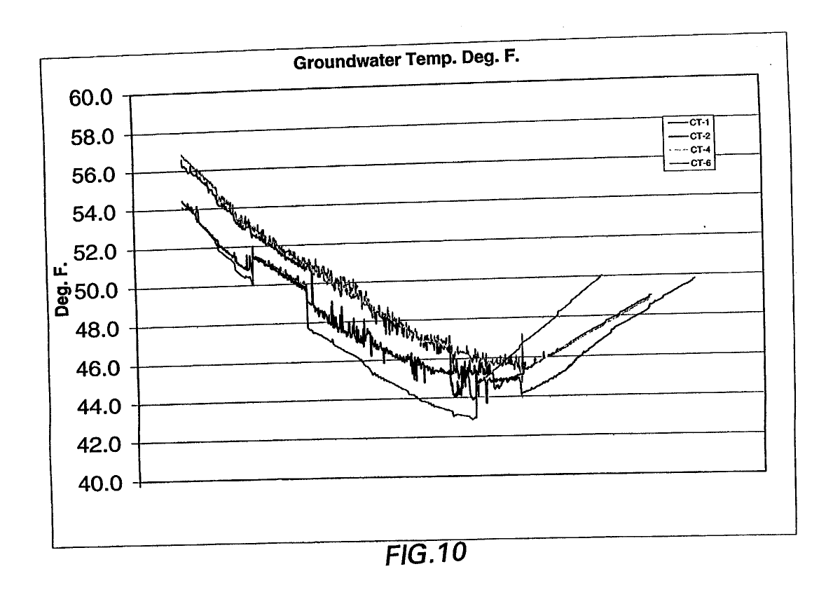

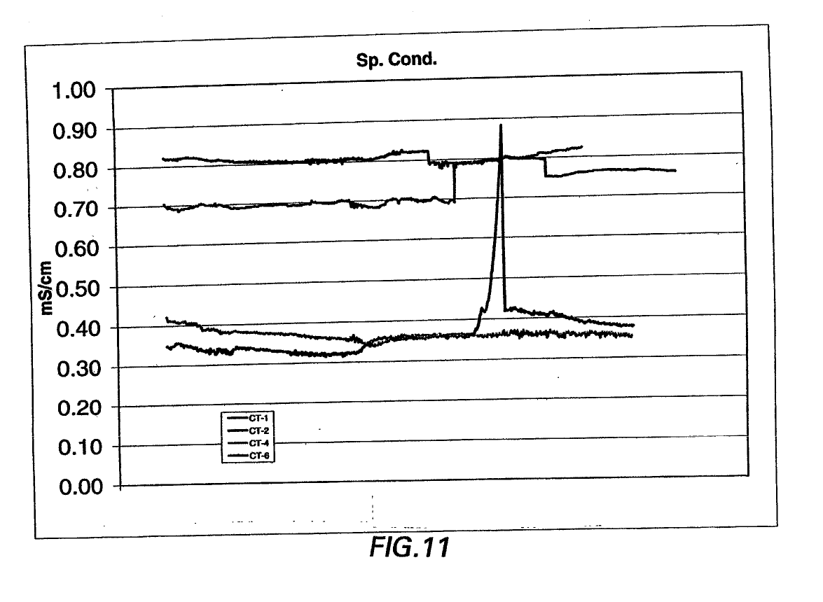

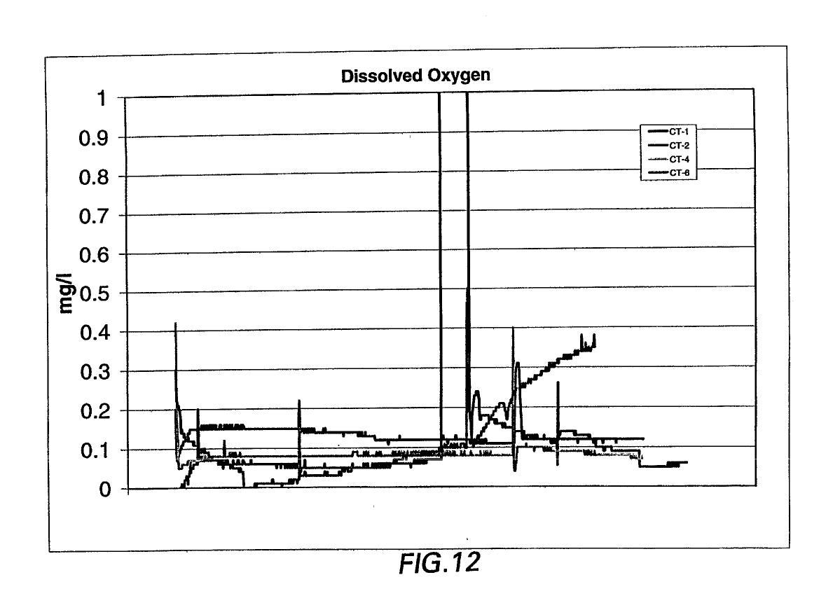

FIGS. 5 to 12 illustrate these profiles for an exemplary PRB site.

The reducing environment of the iron can serve as a useful and convenient indicator of reactivity of the iron media. Under anaerobic conditions that exist in the iron media, zero-valent iron is oxidized by water according to equation 1.

Fe0+2H2O→Fe2++H2(g)+2OH— (1)

The resultant rise in pH can lead to the precipitation of ferrous hydroxide according to equation 2.

Fe2++2OH—→Fe(OH)2(s) KFe(OH)2=8×10−16 (2)

In carbonate-containing waters, rise in pH from the anaerobic corrosion of iron will shift the carbonate-bicarbonate equilibrium (equation 3) and lead to the precipitation of calcium carbonate and ferrous carbonate (siderite) minerals according to equations 4 and 5.

HCO3−+OH—→CO32−+H2O pKa=10.3 (3)

Fe2++CO32−→FeCO3(s) KFeCO3=3.2×10−11 (4)

Ca2++CO32−→CaCO3(s) KCaCO3=2.8×10−9 (5)

The inorganic precipitates, Fe(OH)2, FeCO3 and CaCO3, have been identified in long-term, laboratory iron column studies and in iron-based PRBs in the field. Over time, these precipitates may result in reduced reactivity of the iron surfaces and potential loss in zone porosity.

In an embodiment, the invention provides a remote monitoring, diagnostic, and reporting system and method for monitoring conditions pH that may give rise to inorganic precipitates and other PRB performance characteristics.

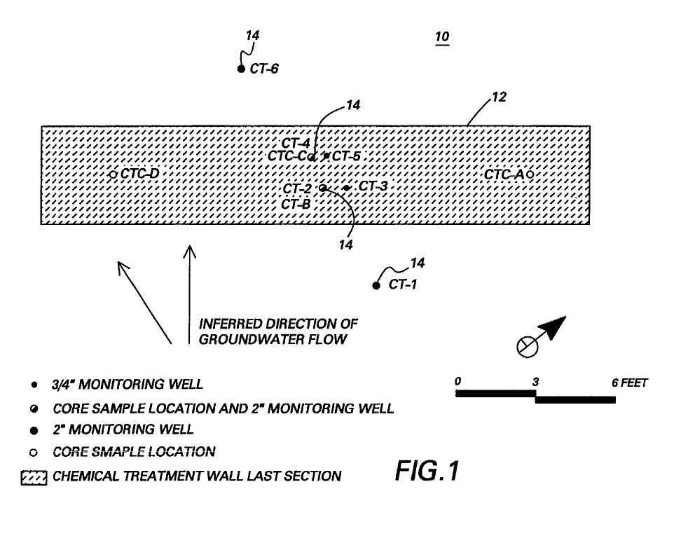

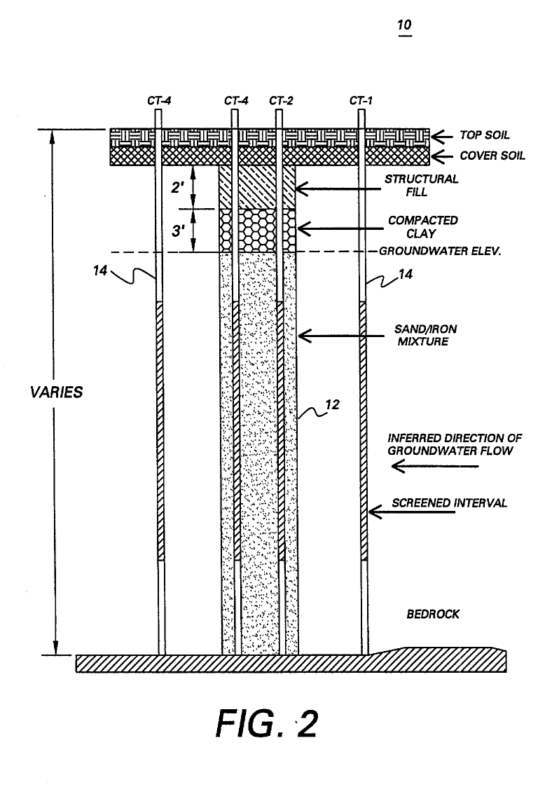

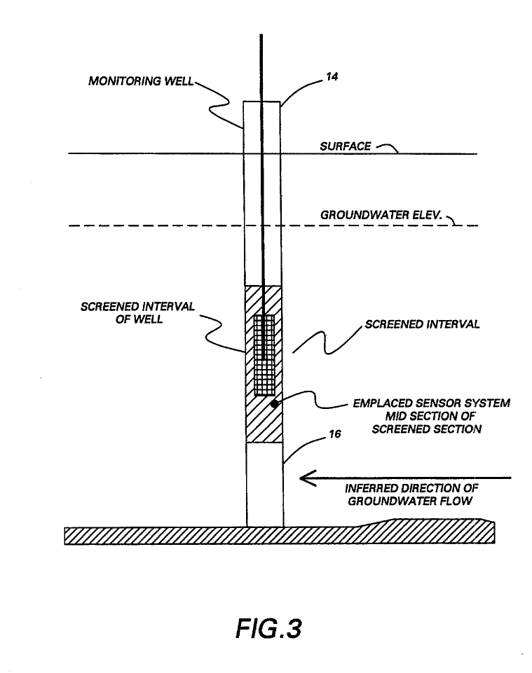

These and other features will become apparent from the drawings and following detailed discussion, which by way of example without limitation describe preferred embodiments of the present invention. in the drawings, FIG. 1 is a schematic representation of a PRB treatment zone with monitoring wells and FIG. 2 is a side elevation view of the PRB zone. FIG. 3 is a side elevation of monitoring well. FIGS. 1 to 3 are described in detail with reference to the Example.

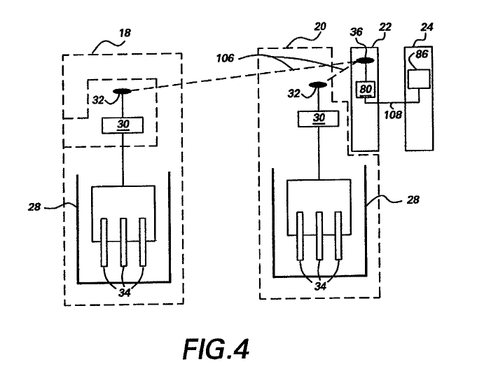

FIG. 4 is a schematic representation of a sensing and monitoring system that includes a sensing module 18 or 20 that can be used in conjunction with a method and system according to the invention including the embodiments shown in FIG. 1, FIG. 2 and FIG. 3. Referring to FIG. 4, module 18 (or 20) can generate signals (data) corresponding to one or more of the groundwater characteristics at the point of the well location. The module 18 or 20 includes a transceiver unit 26 and an electronically coupled sensing unit 28. Transceiver unit 26 includes a receiver 30 and a transmitter 32, which is capable of transmitting data to collector 22, which can be a data collection center. The signals can be communicated 106 from transceiver unit 26 by any of a hardwired communication connection such as an electrical conductor; by a wireless communication connection such as by radio signals, by satellite communications or by combinations of wireless and hardwired connections.

Sensing unit 28 can detect a contaminant of interest or a contaminant level of interest in an influent stream. The sensing unit 28 can includes sensors 34. Suitable types of sensors 34 include a chemical sensor, acoustic wave sensor, fiber optics sensor, solid-state sensor such as a metal oxide semiconductor (MOS), an electrochemical sensor and combinations of such sensors.

The unit 28 includes a communications unit, which is electronically coupled to the unit and is capable of transmitting data to a data collection center. The signals may be communicated, for example, from a well transceiver to the data collection system by at least one hardwired communication connection, such as, but not limited to, an electrical conductor, wireless communication connections, such as, but not limited to, radio signals, satellite communications and combinations of wireless and hardwired connections. The communications unit also typically comprises an antenna that is connected to the transceiver, unless the communications unit is hardwired. The data collection center comprises a center communications unit that is capable of receiving signals from the transceiver and a control that analyzes the signals and generates information on groundwater characteristics. The control of the data collection system typically includes a “user friendly” data acquisition software package that transforms information into easy-to-read formats .

The information transmitted to the data collection center contains data representative of groundwater characteristics important to monitoring PRB performance. The report format provides real-time information and historical trend analysis of groundwater within and around a PRB installation. The real-time information permits a quicker response to undesirable groundwater characteristics, such as a rise in groundwater elevation caused by changes in the hydraulic conductivity of the PRB. It also provides trend analysis of oxidation-reduction potential, pH, specific conductivity, all indicative of an active corrosion environment within an iron PRB.

The monitoring system typically reduces monitoring and reporting costs at a PRB remediation site and provides enhances, readily available data more frequently than conventional monitoring systems that require one or more operators actively purging a number of wells at a given site. It also removes an important source of error in oxidation-reduction potential and dissolved oxygen measurements. That source of error is the introduction of atmospheric gases into the withdrawn groundwater leading to inaccurate measurements. The magnitude of such effects is shown in the Example data, where the low-flow purge method is compared directly with the in-well monitoring system at the same wells over an extended period.

The following Example is illustrative and should not be construed as a limitation on the scope of the claims unless a limitation is specifically recited.

Exampleln this Example, an extended field test was performed to evaluate long-term performance of a PRB test cell containing 100% granular iron. FIG. 1 is a schematic representation of a remediation system 10 that includes the 100% zero-valiant (granular) iron test PRB zone 12 that was installed using a biopolymer slurry construction method as described following. FIG. 2 shows a cross section of a test section of the PRB zone 12 shown in FIG. 1 and FIG. 3 is a cross-section elevation of a typical monitoring well 14.

Four sensors 12 were deployed in different well locations—one up-gradient of the iron zone, two within the iron zone, and one down-gradient of the iron zone. The four well locations were along a transect in the direction of site groundwater flow. Monitoring well locations were selected and installed in and around the PRB test zone 12. The PRB test zone 12 was 21 feet in length, approximately 28 inches in width and approximately 34 feet deep. The test zone 12 was formed by first excavating a trench using a backhoe with an extended boom and a 24-inch bucket. A biopolymer slurry was added to the trench and the level of the slurry was maintained during the excavation to maintain trench side stability. The trench was excavated under slurry to the surface of the bedrock.

Two 6-inch diameter slotted polyvinyl chloride (PVC) temporary development wells were placed into he trench to allow for the later removal of groundwater/biopolymer. Granular iron (33,000 lbs.) and sand (3464 lbs) were mixed in a concrete mixing truck along with water. The iron/sand mixture was then placed into the slurry-filled trench using a tremie pipe. A diversion trench was dug to allow displaced slurry to flow by gravity from the trench to a containment area. Development of the filled trench was completed by pumping out groundwater/bio-polymer. A clean surface of the iron/sand mixture was then exposed by backhoe. A geotextile was placed on top of the iron/sand and five feet of clay was placed and compacted on the geotextile.

Six monitoring wells were installed in and around the PRB test section as shown in FIG. 1. Well locations for wells identified in FIG. 1 as CT-1, CT-3, CT-5 and CT-6 were selected to form a transect through the PRB in the direction of groundwater flow. Four 2-inch wells were used for hydraulic testing and for in-well sensor probes. Two 2-inch wells were placed within the PRB test section (one 6-inches from the PRB up-gradient and one 6-inches from the PRB down-gradient edge) and a 2-inch well was installed in the overburden up-gradient and a 2-inch well was installed down-gradient of the PRB (FIG. 1). As shown in FIG. 3, the monitoring wells had screened intervals of 15 feet in length. The bottoms of the well screens were approximately 6 feet above the bedrock surface. The wells installed in the overburden had filter packs while those in the PRB test section were constructed without filter packs. All wells had bentonite seals and lockable protective casings.

Six ¾-inch wells were used for collection of groundwater samples. One each of the ¾ inch wells was located approximately 24 inches away from each 2-inch well. All monitoring wells were of PVC construction.

Groundwater samples were collected on three occasions over a period of three months. The samples were used for: (1) measurement or analysis of pH, oxidation-reduction potential (ORP), dissolved oxygen (DO), specific conductance, temperature, dissolved iron, viscosity, and biomass (by phospholipid fatty acid (PFLA) analysis); and (2) volatile organic compounds (VOCs) to monitor destruction in the iron/sand mixture. Measurement of pH, ORP, DO, specific conductance, temperature, and viscosity were conducted in the field.

In addition to these monitoring events, data logging sensor probes were installed at the mid-section of each screened interval of each of the four 2-inch diameter wells. These sensor probes monitored groundwater elevations, ORP, pH, specific conductance and DO over a 6-month period.

Low-flow purge is an established technique to sample groundwater, According to low-flow purge, groundwater is pumped from subsurface to surface. The process of bringing groundwater to the surface, however, alters many of the monitoring parameters. Table 2 compares data collected from both a low-flow purge (purge) and in-well data logging sensor probes for three monitoring events over a three month period. The in-well sensor probes provided continuous data shown in FIGS. 5 to 12.

TABLE 2

| WELL | DAY | Method | TEMP | pH | SpCond | DO | ORP |
|---|---|---|---|---|---|---|---|
| CT-1 | 45 | Purge | 11.35 | 6.21 | 810 | 3.54 | −121 |
| | @13:30 | Insitu | 11.94 | 6.57 | 816 | 0.05 | −71 |
| | 65 | Purge | 9.40 | 6.46 | 793 | 0.79 | −145 |
| | @10:55 | Insitu | 11.10 | 6.59 | 811 | 0.06 | −90 |
| | 86 | Purge | 9.30 | 6.40 | 821 | 3.50 | −160 |
| | @10:30 | Insitu | 10.47 | 6.61 | 8.06 | 0.06 | −93 |
| CT-6 | 45 | Purge | 11.05 | 6.31 | 837 | 1.55 | −147 |
| | @14:00 | Insitu | 12.13 | 6.69 | 685 | 0.12 | −413 |
| | 65 | Purge | 8.73 | 6.56 | 820 | 0.65 | −205 |
| | @09:40 | Insitu | 10.89 | 6.70 | 692 | 0.03 | −392 |
| | 86 | Purge | 8.40 | 6.50 | 851 | 2.50 | −185 |
| | @10:45 | Insitu | 8.59 | 6.70 | 694 | 0.04 | −369 |
| CT-3 | 45 | Purge | 10.90 | 8.50 | 461 | 0.65 | −578 |
| CT-2 | @10:00 | Insitu | 13.19 | 9.71 | 356 | 0.15 | −744 |
| CT-3 | 65 | Purge | 10.0 | 8.50 | 461 | 0.65 | −578 |
| CT-2 | @13:00 | Insitu | 11.45 | 9.83 | 343 | 0.15 | −737 |
| CT-3 | 86 | Purge | 9.60 | 9.00 | 524 | 3.30 | −457 |
| CT-2 | @12:30 | Insitu | 10.29 | 9.93 | 330 | 0.14 | −710 |
| CT-5 | 45 | Purge | 10.89 | 9.18 | 427 | 0.45 | −676 |
| CT-4 | @11:00 | Insitu | 13.36 | 9.70 | 409 | 0.06 | −752 |
| CT-5 | 65 | Purge | 7.24 | 9.73 | 438 | 0.71 | −410 |
| CT-4 | @13:40 | Insitu | 11.69 | 9.90 | 382 | 0.08 | −696 |
| CT-5 | 86 | Purge | 9.60 | 9.70 | 469 | 2.60 | −522 |
| CT-4 | @12:50 | Insitu | 10.47 | 10.10 | 373 | 0.08 | −739 |

TABLE 2 shows multiple daily sampling events. The DAY column indicates days after PRB installation. Accuracy of the in-well (in situ) sampling was confirmed by controlled laboratory measurements. In TABLE 2, the high dissolved (DO) values and the more positive oxidation-reduction potential (ORP) values measured by the low-flow purge method were in error, as a groundwater cannot be highly reducing (<−100 mv ORP) and at the same time be characterized by such high concentrations of dissolved oxygen (˜3.5 mg/L). This type of contaminated data is not uncommon when low-flow purge methods are used. The EXAMPLE illustrates the sampling accuracy advantage of in-well measurements according to the invention.

While preferred embodiments of the invention have been described, the present invention is capable of variation and modification and therefore should not be limited to the precise details of the Examples. The invention includes changes and alterations that fall within the purview of the following claims.

1. A method, comprising:
conducting a permeable-reactive barrier (PRB) treatment of a contaminated aqueous medium; and
in-well monitoring effectiveness of the PRB treatment.

2. The method of claim 1, wherein the in-well monitoring is conducted by at least one well placed up to about 25 feet up-gradient of the PRB and at least one well placed up to about 25 feet down-gradient of the PRB.

3. The method of claim 1, wherein the in-well monitoring is conducted by at least one well placed about 1 to about 6 feet up-gradient of the PRB and at least one well placed about 1 to about 6 feet down-gradient of the PRB.

4. The method of claim 1, wherein the in-well monitoring is conducted by at least one well placed about 2 to about 4 feet up-gradient of the PRB and at least one well placed about 2 to about 4 feet down-gradient of the PRB.

5. The method of claim 1, wherein the in-well monitoring is conducted by a plurality of wells arranged substantially along a transect to a PRB zone.

6. The method of claim 1, wherein the in-well monitoring is conducted by a plurality of in-well sensors arranged substantially along a transect to a PRB zone and the transect is defined by a ±20 feet wide horizontal plane that transcribes at least one up-stream monitoring well and at least one down-stream well at a level that is ±5 feet of a mid point of each well open screen interval.

7. The method of claim 1, wherein the in-well monitoring is conducted by a plurality of in-well sensors arranged substantially along a transect to a PRB zone and the transect is defined by a ±10 feet wide horizontal plane that transcribes at least one up-stream monitoring well and at least one down-stream well at a level that is ±3 feet of a mid point of each well open screen interval.

8. The method of claim 1, wherein the in-well monitoring is conducted by a plurality of in-well sensors arranged substantially along a transect to a PRB zone and the transect is defined by a ±6 feet wide horizontal plane that transcribes at least one up-stream monitoring well and at least one down-stream well at a level that is ±1 feet of a mid point of each well open screen interval.

9. The method of claim 1, wherein the in-well monitoring is conducted by a plurality of in-well sensors arranged substantially along a transect to a PRB zone, wherein the transect is defined by flow of contaminated aqueous medium.

10. The method of claim 1, comprising determining flow of contaminated aqueous medium up-gradient, down-gradient and transecting a PRB zone, placing monitoring wells along the flow of contaminated medium and conducting the in-well monitoring with the monitoring wells.

11. The method of claim 1, comprising determining flow of contaminated aqueous medium up-gradient, down-gradient and transecting a PRB zone, placing monitoring wells along the flow of contaminated medium and conducting the in-well monitoring with the monitoring wells, wherein at least one monitoring sensor is placed in-well up-gradient of the PRB zone.

12. The method of claim 1, comprising determining flow of contaminated aqueous medium up-gradient, down-gradient and transecting a PRB zone, placing monitoring wells along the flow of contaminated medium and conducting the in-well monitoring with the monitoring wells, wherein at least one monitoring sensor is placed in-well down-gradient of the PRB zone.

13. The method of claim 1, comprising determining flow of contaminated aqueous medium up-gradient, down-gradient and transecting a PRB zone, placing monitoring wells along the flow of contaminated medium and conducting the in-well monitoring with the monitoring wells, wherein at least one monitoring sensor is placed in-well within the PRB zone.

14. The method of claim 1, comprising determining flow of contaminated aqueous medium up-gradient, down-gradient and transecting a PRB zone, placing monitoring wells along the flow of contaminated medium and conducting the in-well monitoring with the monitoring wells, wherein at least one monitoring sensor is placed in-well up-gradient of the PRB zone, at least one monitoring sensor is placed in-well down-gradient of the PRB zone and ate least one monitoring sensor is placed within the PRB zone.

15. The method of claim 1, comprising monitoring effectiveness by measuring at least one of pH, oxidation-reduction potential and specific conductivity.

16. The method of claim 1, comprising determining nature, extent and velocity of a plume of contaminated aqueous medium and conducting the PRB treatment of the contaminated aqueous medium.

17. The method of claim 1, comprising selecting and providing a barrier zone of reactive material and conducting the PRB treatment with the barrier zone.

18. The method of claim 17, comprising excavating a trench suitable for receiving the reactive material and placing the reactive material within the trench to provide the barrier zone.

19. The method of claim 18, comprising locating the trench so that the reactive material therein lies in the path of a plume of the contaminated aqueous medium.

20. The method of claim 1, wherein the in-well monitoring is accomplished with a sensor containing monitoring well located in the vicinity of a PRB zone.

21. The method of claim 1, wherein the in-well monitoring is accomplished with monitoring wells placed up-gradient and down-gradient of a PRB zone.

22. The method of claim 1, wherein the in-well monitoring is accomplished with a monitoring well placed within the reactive material of a PRB zone.

23. A method of treating a contaminated groundwater, comprising:
sensing a characteristic of the contaminated groundwater with a sensor placed in at least one well emplaced substantially along a transect of a longitudinal axis of a PRB zone; and
remotely monitoring the sensing to determine effectiveness of a remediation treatment of the groundwater.

24. The method of claim 23, wherein a characteristic of the contaminated groundwater is sensed with a sensor placed within the well.

25. The method of claim 23, wherein a characteristic of the contaminated groundwater is sensed with a sensor placed up-graclient and a sensor placed down-gradient of the PRB.

26. The method of claim 23, wherein the sensors are placed substantially along a transect to a PRB zone and the transect is defined by a ±20 feet wide horizontal plane that transcribes at least one up-stream monitoring well and at least one down-stream well at a level that is ±5 feet of a mid point of each well open screen interval.

27. The method of claim 23, wherein the sensors are placed substantially along a transect to a PRB zone and the transect is defined by a ±10 feet wide horizontal plane that transcribes at least one up-stream monitoring well and at least one down-stream well at a level that is ±3 feet of a mid point of each well open screen interval.

28. The method of claim 23, wherein the sensors are placed substantially along a transect to a PRB zone and the transect is defined by a ±6 feet wide horizontal plane that transcribes at least one up-stream monitoring well and at least one down-stream well at a level that is ±1 feet of a mid point of each well open screen interval.

29. The method of claim 23, wherein a characteristic of the contaminated groundwater is sensed with a sensor placed up-gradient of the PRB, a sensor placed down-gradient of the PRB and a sensor placed within the PRB.

30. The method of claim 23, comprising adjusting the treatment of contaminated groundwater according to the monitoring.

31. The method of claim 23, wherein the monitoring comprises sensing a contaminant and transmitting a signal concerning the contaminant to a data collector.

32. The method of claim 31, wherein the data collector collects the signal and transmits information concerning the contaminant derived from the signal.

33. The method of claim 32, wherein the collector transmits the information to a remote monitor.

34. The method of claim 33, wherein the information is transmitted over a web connection, phone modem connection, radio connection, network connection, wireless connection, cellular connection, satellite connection, Internet connection or combinations thereof.

35. The method of claim 33, further comprising outputting a contaminant report from the remote monitor.

36. A method of monitoring a PRB treatment of a contaminated aqueous medium, comprising:
determining flow of the contaminated aqueous medium across a PRB zone to define a transect of the zone from an up-gradient to the zone across the zone to a down-gradient to the zone;
emplacing a monitoring well up-gradient to the zone and a monitoring well down-gradient to the zone substantially along the transect; and
evaluating the performance of the PRB treatment with the wells.

37. The method of claim 36, additionally comprising emplacing a monitoring well within the zone substantially along the transect.

38. The method of claim 36, wherein the transect is a straight line between flow of the contaminated aqueous medium at an up-gradient location to flow of the contaminated aqueous medium at a down-gradient location.

39. The method of claim 36, wherein the transect is defined by a ±20 feet wide horizontal plane that transcribes at least one up-stream monitoring well and at least one down-stream well at a level that is ±5 feet of a mid point of each well open screen interval.

40. The method of claim 36, wherein the transect is defined by a ±10 feet wide horizontal plane that transcribes at least one up-stream monitoring well and at least one down-stream well at a level that is ±3 feet of a mid point of each well open screen interval.

41. The method of claim 36, wherein the transect is defined by a ±6 feet wide horizontal plane that transcribes at least one up-stream monitoring well and at least one down-stream well at a level that is ±1 feet of a mid point of each well open screen interval.

42. A method of evaluating performance of a PRB zone, comprising
emplacing a sensor in a vicinity of the PRB zone; and
measuring at least one of pH, oxidation-reduction potential and specific conductivity with the sensor.

43. The method of claim 42, comprising measuring pH, oxidation-reduction potential and specific conductivity with a plurality of sensors.

44. A system comprising:
a PRB zone to treat a contaminated groundwater;
an in-well sensor located within a gradient of the contaminated groundwater or within the PRB zone to sense a characteristic of the groundwater.

45. The syst em of claim 44, additionally comprising a monitor to receive information concerning the characteristic from the sensor.

46. The syst em of claim 45, wherein the monitor is situated at a location remote from the PRB zone.

47. The syst em of claim 44, comprising at least one well placed up to about 25 feet up-gradient of the PRB and at least one well placed up to about 25 feet down-gradient of the PRB.

48. The system of claim 44, comprising at least one well about 1 to about 6 feet up-gradient of the PRB and at least one well placed about 1 to about 6 feet down-gradient of the PRB.

49. The system of claim 44, comprising at least one well placed about 2 to about 4 feet up-gradient of the PRB and at least one well placed about 2 to about 4 feet down-gradient of the PRB.

50. The system of claim 44, comprising a plurality of in-well sensors placed within the gradient of the contaminated groundwater or within the PRB zone.

51. The system of claim 50, wherein the sensors of the plurality are located along a transect of the PRB zone.

52. The system of claim 51, wherein the transect is defined by a ±20 feet wide horizontal plane that transcribes at least one up-stream monitoring well and at least one down-stream well at a level that is ±5 feet of a mid point of each well open screen interval.

53. The system of claim 51, wherein the transect is defined by a ±10 feet wide horizontal plane that transcribes at least one up-stream monitoring well and at least one down-stream well at a level that is ±3 feet of a mid point of each well open screen interval.

54. The system of claim 51, wherein the transect is defined by a ±6 feet wide horizontal plane that transcribes at least one up-stream monitoring well and at least one down-stream well at a level that is ±1 feet of a mid point of each well open screen interval.

55. The system of claim 44, further comprising a transmitter associated with a sensor to transmit a signal concerning the characteristic.

56. The system of claim 55, further comprising a collector to receive the signal from the transmitter.

57. The system of claim 57, wherein the collector is capable of transmitting a signal concerning the characteristic to a monitor.

58. The system of claim 57, further comprising a communication link that interconnects the data collector and the monitor, the communication link capable of transmitting the signal to enable a user at the monitor to obtain information concerning the contaminant.

59. The system of claim 59, wherein the communication link comprises a web connection.

60. The system of claim 59, wherein the communication link comprises a network.

61. The system of claim 59, wherein the communication link comprises a phone modem connection, radio communication connection, network communication connection, wireless communication system connection, cellular communication connection, satellite communication connection, Web connection, Internet connection or combinations thereof.

62. The system of claim 59, further comprising a two-way communicator between the collector and the sensor to permit selection, activation, de-activation, modification, fine-tuning, manipulation or resetting of the sensor.

63. The system of claim 59, wherein the sensor comprises a vapor sensor, chemical sensor, fiber optics sensor, acoustic wave sensor solid-state sensor, metal oxide sensor, an electrochemical sensor or combinations thereof.

64. The system of claim 44, comprising a plurality of sensors emplaced in respective plurality of wells arranged substantially along a transect to the PRB zone.

65. The system of claim 44, comprising a plurality of sensors emplaced in respective plurality of wells arranged substantially along a longitudinal axis of the PRB zone facing flow of the contaminated aqueous medium.

66. A system comprising:
a PRB zone to treat a contaminated groundwater;
a sensor located substantially along a transect of flow of the contaminated groundwater from an up-gradient location, across the PRB zone to a down-gradient location.
